(19) United States
(12) Patent Application Publication
(10) Pub. No.: US 2019/0292015 A1
(43) Pub. Date: Sep. 26, 2019

(54) ROPE SWAY DETECTION AND MITIGATION FOR ELEVATOR SYSTEM

(71) Applicant: Otis Elevator Company, Farmington, CT (US)

(72) Inventors: Bradley Armand Scoville, Farmington, CT (US); Sam Wong, Bridgeport, CT (US); William Talbot, New Hartford, CT (US)

(21) Appl. No.: 16/359,017

(22) Filed: Mar. 20, 2019

Related U.S. Application Data
(60) Provisional application No. 62/645,511, filed on Mar. 20, 2018.

(51) Int. Cl. B66B 7/12; B66B 5/00

(52) U.S. Cl. CPC B66B 7/1215; B66B 7/06; B66B 5/0031

(57) ABSTRACT

A rope sway detection system of an elevator system includes a magnetic pickup located adjacent to a suspension member of an elevator system. The magnetic pickup is configured to detect a movement of the suspension member via a change in a magnetic field at the magnetic pickup. A signal processing unit is operably connected to the magnetic pickup. The signal processing unit is configured to determine a maximum amplitude of a sway of the suspension member based on the change in the magnetic field, compare the maximum amplitude to a preselected threshold, and signal a change in operation of the elevator system based on an actual or predicted exceedance of the threshold.

### CROSS-REFERENCE TO RELATED APPLICATIONS

This application claims the benefit of U.S. Provisional Application No. 62/645,511, filed Mar. 20, 2018, which is incorporated herein by reference in its entirety.

### BACKGROUND

Exemplary embodiments pertain to the art of elevator systems. More particularly, the present disclosure relates to detection and correction of suspension member sway of elevator systems.

Elevator systems are useful for carrying passengers, cargo, or both, between various levels in a building. Some elevators are traction based and utilize suspension members such as ropes or belts for supporting the elevator car and achieving the desired movement and positioning of the elevator car.

Rope sway of elevator systems can cause damage to ropes and other objects or equipment in the hoistway of the elevator system. Further, rope sway causes undesirable vibrations, which leads to passenger discomfort. Rope sway is typically not measured directly, but is instead assessed by sensing contributing conditions, such as building sway or vibration. When building sway is detected, action is taken to limit travel of the elevator cars of the elevator system, and/or to stop operation of the elevator cars until the building sway event passes.

Utilizing secondary conditions such as building sway to assess rope sway may result in false triggers when a rope sway event is not occurring, and may fail to trigger a response when a rope sway event is occurring.

### BRIEF DESCRIPTION

In one embodiment, a rope sway detection system of an elevator system includes a magnetic pickup located adjacent to a suspension member of an elevator system. The magnetic pickup is configured to detect a movement of the suspension member via a change in a magnetic field at the magnetic pickup. A signal processing unit is operably connected to the magnetic pickup. The signal processing unit is configured to determine a maximum amplitude of a sway of the suspension member based on the change in the magnetic field, compare the maximum amplitude to a preselected threshold, and signal a change in operation of the elevator system based on an actual or predicted exceedance of the threshold.

Additionally or alternatively, in this or other embodiments two or more magnetic pickups are located at the hoistway, at some angle apart relative to a rope central axis.

Additionally or alternatively, in this or other embodiments wherein the magnetic pickup is selectably retractable.

Additionally or alternatively, in this or other embodiments a power driver is operably connected to the magnetic pickup.

Additionally or alternatively, in this or other embodiments the power driver and the magnetic pickup are configured to emit an actuation signal to disrupt sway of the suspension member.

Additionally or alternatively, in this or other embodiments the power driver and the magnetic pickup are configured to emit a holding signal to attract the suspension member to the magnetic pickup.

In another embodiment, an elevator system includes a hoistway, an elevator car located in the hoistway, a suspension member operably connected to the elevator car to move the elevator car along the hoistway, and a rope sway detection system located in the hoistway. The rope sway detection system includes a magnetic pickup positioned adjacent to the suspension member. The magnetic pickup is configured to detect a movement of the suspension member via a change in a magnetic field at the magnetic pickup. A signal processing unit is operably connected to the magnetic pickup. The signal processing unit is configured to determine a maximum amplitude of a sway of the suspension member based on the change in the magnetic field, compare the maximum amplitude to a preselected threshold, and signal a change in operation of the elevator system based on an actual or predicted exceedance of the threshold.

Additionally or alternatively, in this or other embodiments two or more magnetic pickups are located at the hoistway, at some angle apart relative to a rope central axis.

Additionally or alternatively, in this or other embodiments the magnetic pickup is selectably retractable.

Additionally or alternatively, in this or other embodiments a power driver is operably connected to the magnetic pickup.

Additionally or alternatively, in this or other embodiments the power driver and the magnetic pickup are configured to emit an actuation signal to reduce sway of the suspension member.

Additionally or alternatively, in this or other embodiments the power driver and the magnetic pickup are configured to emit a holding signal to attract the suspension member to the magnetic pickup.

Additionally or alternatively, in this or other embodiments the magnetic pickup is located at or near a drive sheave of the elevator system.

Additionally or alternatively, in this or other embodiments the suspension member is a rope formed from a plurality of metallic wires.

Additionally or alternatively, in this or other embodiments the rope sway detection system is configured to sense one or more of speed of the elevator car or operational frequency of an elevator drive.

In yet another embodiment, a method of detecting movement of a suspension member of an elevator system includes positioning a magnetic pickup adjacent to the suspension member, sensing a change in a magnetic field of the magnetic pickup indicative of movement of the suspension member, and determining a maximum amplitude of the movement based on the change in the magnetic field.

Additionally or alternatively, in this or other embodiments the maximum amplitude is compared to a predetermined threshold, and operation of the elevator system is changed based on an actual or predicted exceedance of the threshold.

Additionally or alternatively, in this or other embodiments an actuation signal is transmitted from the magnetic pickup toward the suspension member to reduce movement of the suspension member.

Additionally or alternatively, in this or other embodiments a holding signal is emitted from the magnetic pickup to attract the suspension member to the magnetic pickup to reduce movement of the suspension member.

Additionally or alternatively, in this or other embodiments one or more of speed of the elevator car or operational frequency of an elevator drive are sensed.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of an elevator system;

FIG. 2 is cross-sectional view of an embodiment of a rope for an elevator system;

FIG. 3 is an illustration of an embodiment of a rope sway detection system of an elevator system;

FIG. 4 is an illustration of an embodiment of a magnetic pickup;

FIG. 5 is another illustration of an embodiment of a rope sway detection system of an elevator system;

FIG. 6 is an illustration of a method of detecting movement of an elevator suspension member;

FIG. 7 is another illustration of an embodiment of a rope sway detection and actuation system of an elevator system; and

FIG. 8 is yet another illustration of an embodiment of a rope sway detection and actuation system of an elevator system.

### DETAILED DESCRIPTION

A detailed description of one or more embodiments of the disclosed apparatus and method are presented herein by way of exemplification and not limitation with reference to the Figures.

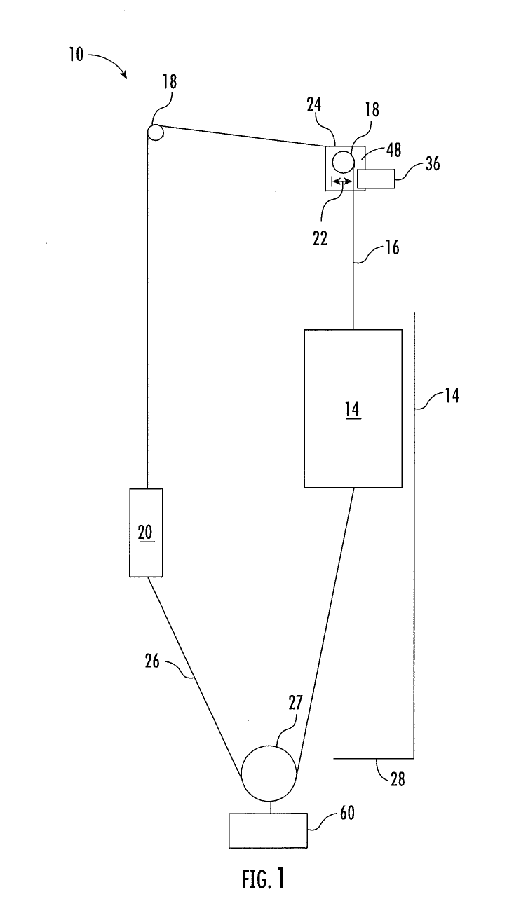

Shown in FIG. 1 is an embodiment of an elevator system 10. Features of the elevator system 10 that are not required for an understanding of the present invention (such as the guide rails, safeties, etc.) are not discussed herein. The elevator system 10 includes an elevator car 12 operatively suspended or supported in a hoistway 14 with one or more suspension members, for example, suspension ropes 16. The one or more suspension ropes 16 interact with one or more sheaves 18 to be routed around various components of the elevator system 10. The one or more suspension ropes 16 are also connected to a counterweight 20, which is used to help balance the elevator system 10 and reduce the difference in rope tension on both sides of the one or more sheaves 18 during operation. The sheaves 18 each have a diameter 22, which may be the same or different than the diameters of the other sheaves 18 in the elevator system 10. At least one of the sheaves 18 could be a drive sheave driven by a machine 24. Movement of the drive sheave by the machine 24 drives, moves and/or propels (through traction) the one or more suspension ropes 16 that are routed around the drive sheave 18 thereby moving the elevator car 12 along the hoistway 14. The elevator system 10 may further include one or more compensation ropes 26 extending from the elevator car 12 toward a hoistway pit 28 around a compensation sheave 27 and up to the counterweight 20. A tie-down mass 60 may be disposed in the hoistway pit 28 and affixed to the compensation sheave 27. The compensation ropes 26, compensation sheave 27 and tie-down mass 60 stabilize motion of the elevator car 12 along the hoistway 14.

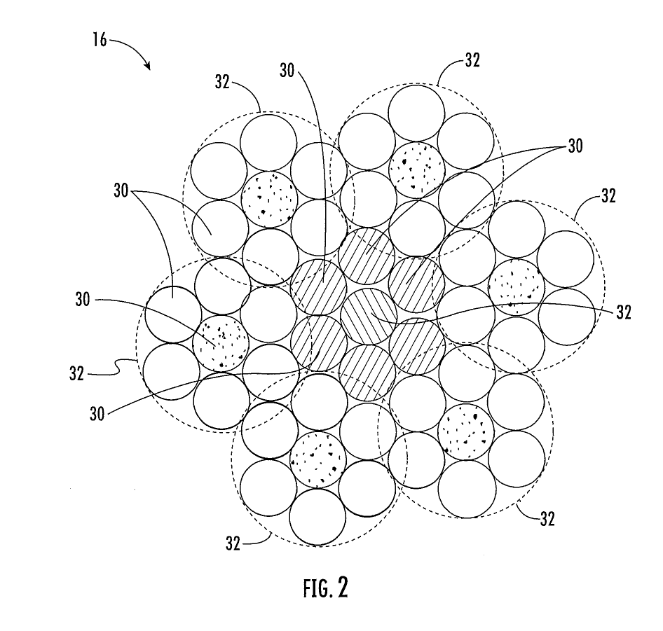

Referring now to FIG. 2, the suspension ropes 16 and/or the compensation ropes 26 may be formed from a plurality of wires 30, for example, steel wires 30, which in some embodiments are formed into one or more strands 32. While ropes 16 are described herein, one skilled in the art will readily appreciate that the present disclosure may also be applied to use with elevator systems 10 having coated steel belts or other structures as suspension members.

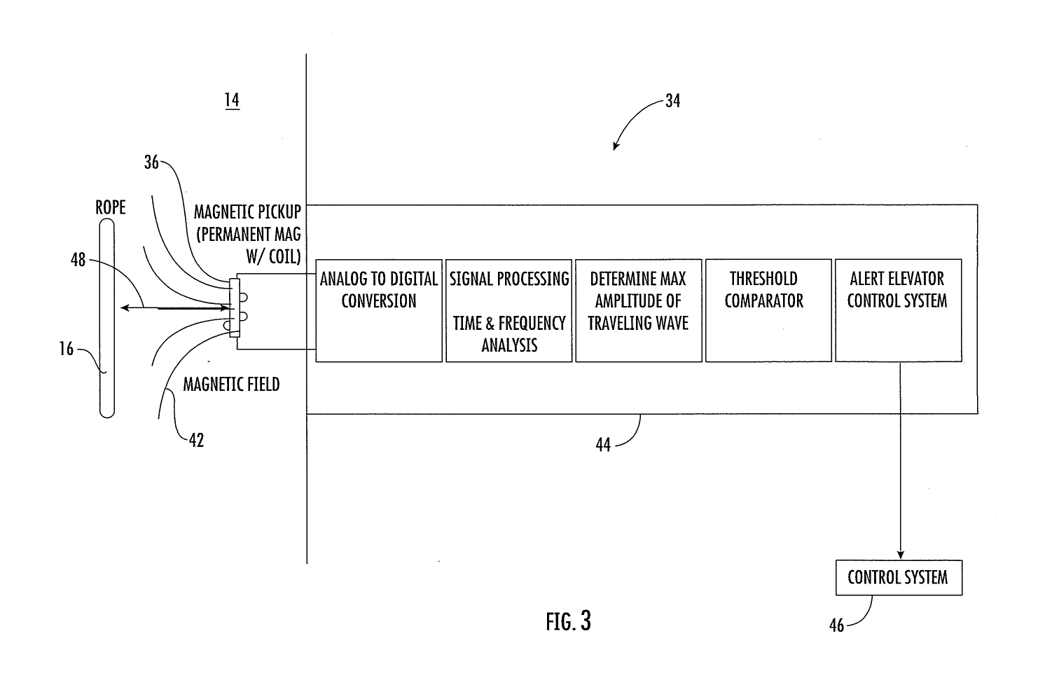

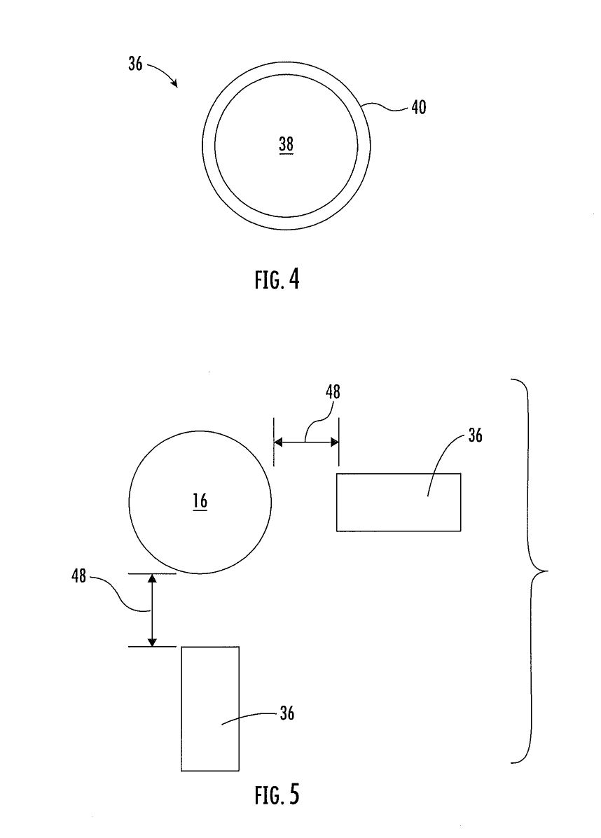

Referring now to FIG. 3, a rope sway detection system 34 is located in the hoistway 14 to detect sway of the suspension ropes 16 and/or the compensation ropes 26 during operation of the elevator system 10. While the description below utilizes as an example the detection of sway of suspension ropes 16, one skilled in the art will readily appreciate that such a rope sway detection system 34 may similarly be applied to detect sway of compensation ropes 26. The rope sway detection system 34 includes one or more sensors positioned in the hoistway 14 to directly detect sway of the suspension ropes 16. In some embodiments, the one or more sensors are one or more magnetic pickups 36. As shown in FIG. 4, the magnetic pickup 36 includes a permanent magnet 38, with a coil 40 surrounding the permanent magnet 38. Referring again to FIG. 3, the magnetic pickup 36 is placed nearby the suspension rope 16.

Movement of the suspension rope 16 relative to the magnetic pickup 36 causes a change in a magnetic field 42 of the magnetic pickup 36, thus resulting in a change in voltage across the coil 40. The measured voltage is analyzed and processed at a signal processing unit 44 to infer a maximum amplitude of a travelling wave of suspension rope 16 movement. The inferred maximum amplitude is compared to a threshold, and the result is communicated to an elevator control system 46 so that proper action, such as restricting movement of the elevator car 12, or stopping operation of the elevator system 10 may be taken.

As shown in FIG. 1, the magnetic pickup 36 is placed along the suspension rope 16 at or near the drive sheave 18. At such a location, amplitude of movement of the suspension rope 16 is relatively small, thus the magnetic pickup 36 may be placed near the suspension rope 16 with a relatively small air gap 48 between the magnetic pickup 36 and the suspension rope 16. Such a placement improves sensitivity of measurement of the suspension rope 16 movement, while having a relatively low risk of collision between the suspension rope 16 and the magnetic pickup 36. It is to be appreciated, though, that the magnetic pickup 36 may be located at another location along the hoistway 14, or when multiple magnetic pickups 36 are utilized, they may be placed at locations other than at or near the drive sheave 18.

Referring to FIG. 5, more than one magnetic pickup 36 may be utilized in detection of suspension rope 16 sway. In one embodiment, two magnetic pickups 36 are located at a sensing location, such as at or near the drive sheave 18. In the embodiment of FIG. 4, the magnetic pickups 36 are positioned at some angle apart relative to a rope central axis, thus the rope sway detection system 34 may detect and determine rope sway in more than one direction. The angle may be 90 degrees, as shown in FIG. 4, or may alternatively be some other suitable angle. In other embodiments, the magnetic pickups 36 may be positioned in the hoistway 14 to be selectably retractable as the elevator car 12 travels along the hoistway 14.

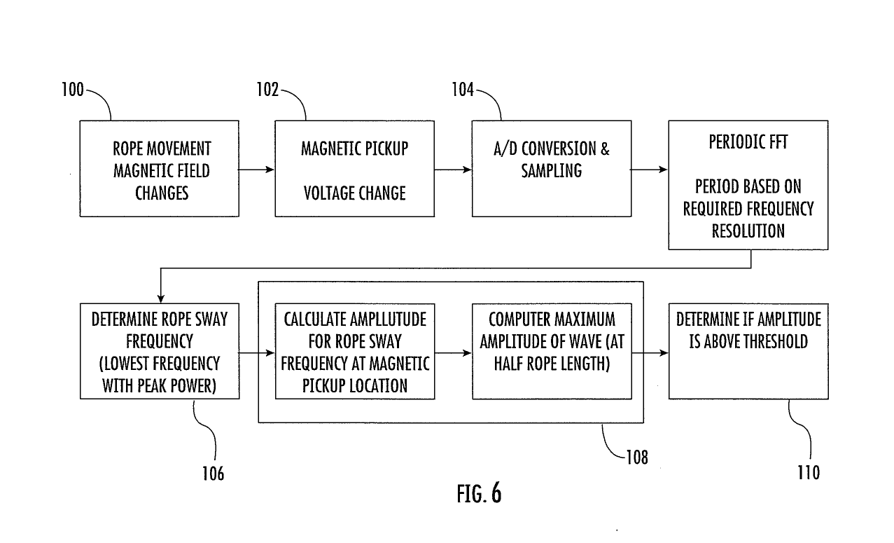

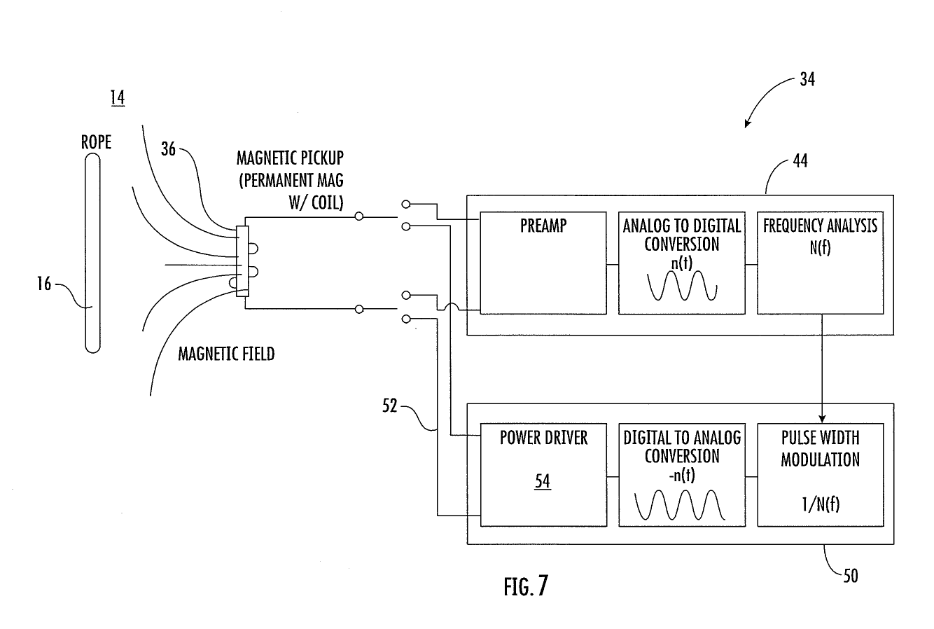

A method of operating the rope sway detection system 34 is illustrated in FIG. 6. In block 100, the suspension rope 16 moves, and triggers a magnetic field change at the magnetic pickup 36. At block 102, the change in magnetic field change causes a voltage change at the magnetic pickup 36. At block 104, the signal processing unit 44 performs analog to digital conversion of the voltage signal, and the rope sway frequency is determined at block 106. At block 108, a maximum amplitude of the traveling wave of the rope sway is determined at the signal processing unit 44. The determination of the maximum amplitude may include factors such as rope 16 length and/or weight of the elevator car 12. The signal processing unit 44 compares the maximum amplitude to a preselected threshold, and if the threshold is exceeded the rope sway detection system 34 signals the elevator control system 46 to take action at block 110, such as restricting operation and/or stopping operation of the elevator system 10.

Further, in some embodiments, analysis by the signal processing unit 44 may be predictive, looking at how the threshold changes over time and then signaling the elevator control system 46 in advance of a predicted sway event to change operation of the elevator system 10 based on prediction of the sway event. Further, in other embodiments, the magnetic pickup 36 may be wired to the elevator control system 46 and the signal processing logic could be located in the elevator control system 46.

In addition to sway of the suspension rope 16 and sway of the compensation rope 26, other operational properties of the elevator system 10 may be sensed or monitored by the rope sway detection system 34. For example, the rope sway detection system 34 may be utilized to sense an operational frequency of the elevator drive (not shown) that commands voltage to the machine 24 with pulse width modulation (PWM). PWM has one or more frequencies that can be observed by the magnetic pickup 36, since it is in close proximity to the drive & motor windings.

Further, the magnetic pickup 36 may detect variation in suspension rope 16 surface passing the magnetic pickup 36, and based on the sensed frequency, the speed of the elevator car 12 may be determined. Further, the magnetic pickup 36 may be utilized for load sensing of the elevator car 12 and/or relative rope 16 tension in a system 10 with multiple ropes 16 and multiple magnetic pickups 36.

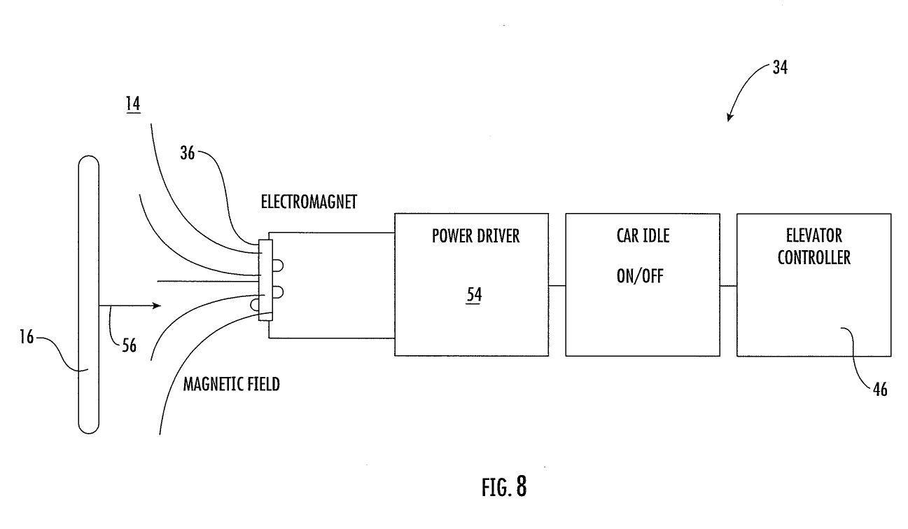

In some embodiments, such as shown in FIG. 7, the rope sway detection system 34 may include an actuation portion 50. Upon determination of a frequency of the rope sway at the signal processing unit 44, the actuation portion 50 generates an actuation signal 52 to induce a magnetic field with an inverse frequency response of the measured signal. The actuation signal 52 is emitted through the magnetic pickup 36, or alternatively through a secondary emitter, via a power driver 54. The actuation signal 52 acts as disruptive interference to the rope 16 sway, thus decreasing the movement of the rope 16.

Additionally, as shown in FIG. 8, once rope 16 sway is detected by the rope sway detection system 34, and the elevator control system 46 signals to stop movement of the elevator car 12, the power driver 52 and the magnetic pickup 36 may be utilized to generate a holding signal 56, a magnetic field of the magnetic pickup 36 to attract and hold the rope 16 at the magnetic pickup 36, thus stopping or decreasing sway of the suspension rope 16 while the elevator car 12 is idle.

The rope sway detection system 34 disclosed herein provides direct sensing and measurement of rope sway, and also solutions for reducing and or stopping rope sway once detected. The system is relatively low cost, and may be easily implemented into existing elevator systems.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A rope sway detection system of an elevator system, comprising:
a magnetic pickup disposed adjacent to a suspension member of an elevator system, the magnetic pickup configured to detect a movement of the suspension member via a change in a magnetic field at the magnetic pickup; and
a signal processing unit operably connected to the magnetic pickup, the signal processing unit configured to:
determine a maximum amplitude of a sway of the suspension member based on the change in the magnetic field;
compare the maximum amplitude to a preselected threshold; and
signal a change in operation of the elevator system based on an actual or predicted exceedance of the threshold.

2. The rope sway detection system of claim 1, further comprising two or more magnetic pickups disposed at the hoistway, at some angle apart relative to a rope central axis.

3. The rope sway detection system of claim 1, wherein the magnetic pickup is selectably retractable.

4. The rope sway detection system of claim 1, further comprising a power driver operably connected to the magnetic pickup.

5. The rope sway detection system of claim 4, wherein the power driver and the magnetic pickup are configured to emit an actuation signal to disrupt sway of the suspension member.

6. The rope sway detection system of claim 4, wherein the power driver and the magnetic pickup are configured to emit a holding signal to attract the suspension member to the magnetic pickup.

7. An elevator system comprising:
a hoistway;
an elevator car disposed in the hoistway;
a suspension member operably connected to the elevator car to move the elevator car along the hoistway; and
a rope sway detection system disposed in the hoistway, including:
a magnetic pickup disposed adjacent to the suspension member, the magnetic pickup configured to detect a movement of the suspension member via a change in a magnetic field at the magnetic pickup; and
a signal processing unit operably connected to the magnetic pickup, the signal processing unit configured to:
determine a maximum amplitude of a sway of the suspension member based on the change in the magnetic field;
compare the maximum amplitude to a preselected threshold; and
signal a change in operation of the elevator system based on an actual or predicted exceedance of the threshold.

8. The elevator system of claim 7, further comprising two or more magnetic pickups disposed at the hoistway, at some angle apart relative to a rope central axis.

9. The elevator system of claim 7, wherein the magnetic pickup is selectably retractable.

10. The elevator system of claim 7, further comprising a power driver operably connected to the magnetic pickup.

11. The elevator system of claim 10, wherein the power driver and the magnetic pickup are configured to emit an actuation signal to reduce sway of the suspension member.

12. The elevator system of claim 10, wherein the power driver and the magnetic pickup are configured to emit a holding signal to attract the suspension member to the magnetic pickup.

13. The elevator system of claim 7, wherein the magnetic pickup is disposed at or near a drive sheave of the elevator system.

14. The elevator system of claim 7, wherein the suspension member is a rope formed from a plurality of metallic wires.

15. The elevator system of claim 7, wherein the rope sway detection system is configured to sense one or more of speed of the elevator car, operational frequency of an elevator drive, load sensing of the elevator car, or relative suspension member tension.

16. A method of detecting movement of a suspension member of an elevator system, comprising:
positioning a magnetic pickup adjacent to the suspension member;
sensing a change in a magnetic field of the magnetic pickup indicative of movement of the suspension member; and
determining a maximum amplitude of the movement based on the change in the magnetic field.

17. The method of claim 16, further comprising:
comparing the maximum amplitude to a predetermined threshold; and
changing operation of the elevator system based on an actual or predicted exceedance of the threshold.

18. The method of claim 16, further comprising transmitting an actuation signal from the magnetic pickup toward the suspension member to reduce movement of the suspension member.

19. The method of claim 16, further comprising emitting a holding signal from the magnetic pickup to attract the suspension member to the magnetic pickup to reduce movement of the suspension member.

20. The method of claim 16, further comprising sensing one or more of speed of an elevator car, operational frequency of an elevator drive, load sensing of the elevator car and/or relative suspension member tension via the magnetic pickup.
